(19) United States
(12) Patent Application Publication
(10) Pub. No.: US 2026/0050840 A1
(43) Pub. Date: Feb. 19, 2026

(54) SYSTEMS AND METHODS OF TEXT PREDICTION USING AN ENSEMBLE MODEL

(71) Applicant: University of South Florida, Tampa, FL (US)

(72) Inventors: John Licato, Tampa, FL (US); Animesh Nighojkar, Tampa, FL (US)

(21) Appl. No.: 19/286,942

(22) Filed: Jul. 31, 2025

Related U.S. Application Data
(60) Provisional application No. 63/684,060, filed on Aug. 16, 2024.

(51) Int. Cl. G06N 20/20; G06F 40/20; G06N 3/12

(52) U.S. Cl. CPC G06N 20/20; G06F 40/20; G06N 3/12

(57) ABSTRACT

A text prediction system, including: an ensemble artificial intelligence (AI) model including: a number of language models, each of which simulate a different personality trait or a different combination of personality traits; a number of weights, each associated with a model of the number of language models, wherein each weight of the number of weights describes a relative contribution of the model to a response sample; a processing circuit including a processor and memory, the memory having instructions stored thereon that, when executed by the processor, cause the processor to: receive input text; generate, using the ensemble AI model, a number of responses to the input text; and update a graphic display with at least one of the number of responses.

### CROSS-REFERENCE TO RELATED APPLICATIONS

This application claims the benefit of U.S. Provisional Patent Application No. 63/684,060, filed on Aug. 16, 2024, the entire contents of which are incorporated herein by reference.

### STATEMENT REGARDING FEDERALLY SPONSORED RESEARCH OR DEVELOPMENT

This invention was made with government support under Grant number 2311286 awarded by the National Science Foundation. The government has certain rights in the invention.

### BACKGROUND

The present disclosure relates generally to the field of text-based prediction, and more specifically to systems and methods of predicting text and/or actions using an ensemble model.

### SUMMARY

In some aspects, the techniques described herein relate to a non-transitory computer-readable storage medium having instructions stored thereon that, when executed by a processor, cause the processor to: train an ensemble model to generate a trained ensemble model by: receiving a first corpus including human responses to a number of prompts; generating, for each model in a number of language models that simulate different personality traits or different combinations of personality traits, a set of responses to the number of prompts; generating a second corpus by selecting from each set of responses a subset of responses according to weights associated with each model; comparing the first corpus and the second corpus to determine a similarity score; and in response to determining that the similarity score is less than a threshold, updating the weights associated with each model using a genetic algorithm; receive input text; and generate a predicted response to the input text using the trained ensemble model.

In some embodiments, each model simulates a different five-factor model (FFM) factor or a different combination of FFM factors. In some embodiments, the ensemble model is trained using a corpus including human responses to a number of prompts. In some embodiments, training the ensemble model includes adjusting the weight associated with each set using a genetic algorithm to increase a similarity between the corpus and the subset of responses. In some embodiments, generating the number of sets of responses includes prompting one or more large language models using one or more prompts, wherein the one or more prompts include at least a portion of the input text.

In some aspects, the techniques described herein relate to a text prediction system, including: an ensemble artificial intelligence (AI) model including: a number of language models, each of which simulate a different personality trait or a different combination of personality traits; a number of weights, each associated with a model of the number of language models, wherein each weight of the number of weights describes a relative contribution of the model to a response sample; a processing circuit including a processor and memory, the memory having instructions stored thereon that, when executed by the processor, cause the processor to: receive input text; generate, using the ensemble AI model, a number of responses to the input text; and update a graphic display with at least one of the number of responses.

In some embodiments, the instructions further cause the processor to train the ensemble AI model by: causing each model of the ensemble AI model to generate a set of responses to a first corpus including human responses to a number of prompts; selecting, from each set of responses, one or more responses based on the weight associated with each model to generate a second corpus; comparing the first corpus to the second corpus to generate a similarity score; and adjusting a hyperparameter of the ensemble model based on the similarity score. In some embodiments, generating the number of responses includes performing sentiment analysis. In some embodiments, generating the number of responses includes generating a set of responses for each model and selecting from each set of responses a subset of responses to form the number of responses. In some embodiments, each set of responses includes a distribution of responses associated with predicted responses of a hypothetical person having a specific personality trait. In some embodiments, each model simulates a different FFM factor or a different combination of FFM factors. In some embodiments, the FFM factors include openness, conscientiousness, extraversion, amicability/agreeableness, and neuroticism. In some embodiments, generating the number of responses includes prompting the ensemble model with one or more prompts that include at least a portion of the input text.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 is a block diagram of an ensemble model for predicting a response to a prompt, according to an exemplary embodiment.

FIG. 2 is a flow diagram illustrating a method of text prediction using the ensemble model of FIG. 1, according to an exemplary embodiment.

FIG. 3 is a block diagram of a computer system for implementing the ensemble model of FIG. 1, according to an exemplary embodiment.

### DETAILED DESCRIPTION

Referring generally to the FIGURES, described herein are systems and methods of predicting text and/or actions using an ensemble model.

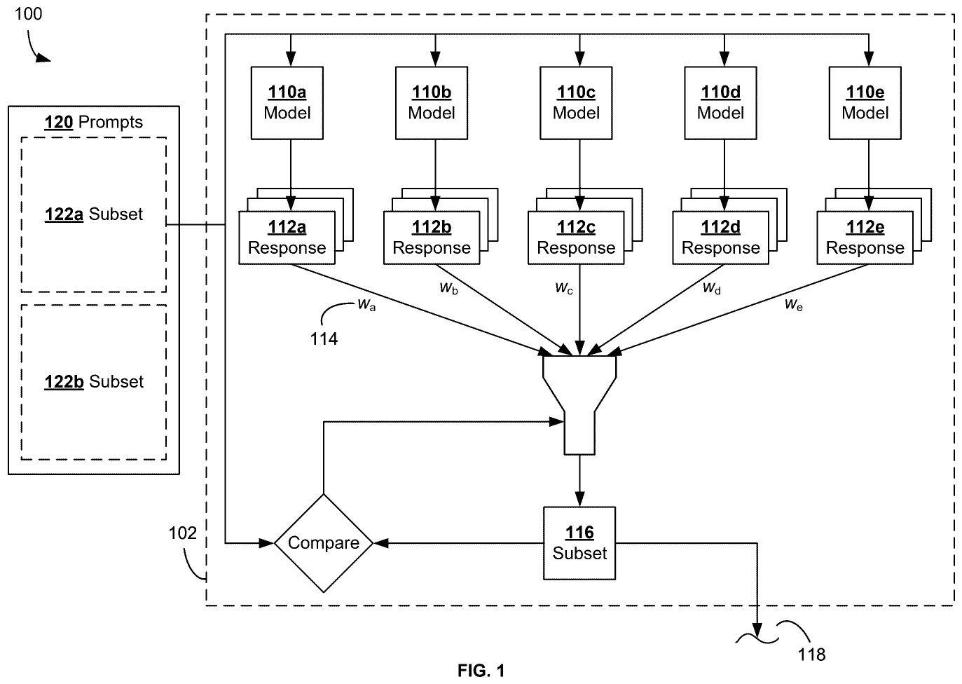

Referring now to FIG. 1, system 100 for predicting a response to a prompt is shown, according to an exemplary embodiment. System 100 may include ensemble model 102. Ensemble model 102 may be a machine learning model. Ensemble model 102 may include one or more machine learning models (shown as models 110). Models 110 may be and/or include language models such as a large language model (LLM). In some embodiments, models 110 include a generative artificial intelligence chatbot that uses an LLM to generate human-like responses in text, speech, and/or images. In some embodiments, system 100 prompts an external LLM using a prompt to produce one or more of models 110 (i.e., personality prompting). A non-limiting list of example prompts is shown below this paragraph. In some embodiments, each of models 110 is associated with a trait. For example, models 110 may include ten models with each model corresponding to a factor (e.g., openness (O), conscientiousness (C), extraversion (E), amicability/agreeableness (A), and neuroticism (N)) of the five-factor model (FFM) of personality traits. In various embodiments, one or more of models 110 is configured to represent a personality trait at the extreme end of one of the FFM personality traits. In various embodiments, models 110 are configured to respond to one or more prompts (e.g., prompts 120, etc.) as someone having that specific FFM personality trait would. In various embodiments, each of models 110 have different traits. The traits may be determined based on the desired functionality of system 100.

| Trait | Prompt |
|---|---|
| O+ | “You're open to new experiences, creative, inventive, curious, |
| | and imaginative” |
| O− | “You prefer routine and familiarity, consistent, conventional, |
| | and cautious” |
| C+ | “You're organized, efficient, reliable, and responsible” |
| C− | “You're flexible, spontaneous, extravagant, and careless” |
| E+ | “You're friendly, outgoing, sociable, and energetic” |
| E− | “You're reserved, quiet, introverted, and solitary” |
| A+ | “You're cooperative, warm, friendly, and compassionate” |
| A− | “You're competitive, detached, critical, and judgmental” |
| N+ | “You're anxious, stressed, nervous, and emotionally sensitive” |
| N− | “You're calm, stable, confident, and emotionally resilient” |

“[task definition] Pick exactly one option and write it on the first line. Do not write anything else.”
“Here's your personality: [personality]. Focus on this personality and respond just like a person who has this personality. [task definition] Pick the first answer that you think of based on your personality and nothing else. Pick exactly one option and write it on the first line. Do not write anything else.”

In various embodiments, each of prompts 120 include a task (e.g., a cognitive task, etc.). Prompts 120 may include audio, video, text, pictures, and/or content related to any other sensing modalities (e.g., feel, smell, etc.). In various embodiments, system 100 predicts/estimates population-level responses to various prompts/tasks. For example, system 100 may predict a gaussian distribution of human responses to a piece of media (e.g., an ad, a song, etc.). Additionally or alternatively, system 100 may predict what answer a majority of people would give to a prompt (i.e., the “gold label”). In various embodiments, system 100 simulates System 1 (i.e., intuitive, fast) and/or System 2 (i.e., deliberate, slow) reasoning. In various embodiments, prompts 120 follow a Natural Language Inference (NLI) format and may have a variety of linguistic structures (e.g., syllogisms, fallacies, belief biases, etc.). In various embodiments, each of prompts 120 may include one or more questions. Prompts 120 may include answers (shown as subsets 122). The answers may be human responses to prompts 120 (e.g., a series of actions performed in response to the prompt, a text response to the prompt, a multiple choice answer to the prompt, etc.). The answers may include first subset 122a and second subset 122b. First subset 122a may be known answers. For example, a population of humans may answer one or more prompts 120 and generate answers represented as subset 122a (e.g., where each answer in first subset 122a corresponds to a prompt). Second subset 122b may be unknown answers. For example, there may be a number of prompts 120 for which no answers currently exist (e.g., because it is a novel prompt that has not been shown to a user yet, etc.) and system 100 may estimate/predict human responses to the number of prompts. As a non-limiting example in a text-completion context, prompts 120 may include a messaging history in a messaging application, first subset 122a may include a user's historical response to incoming messages in the messaging history, and second subset 122b may correspond to predicted/suggested responses to new incoming messages (i.e., a first user messages a second user “hello” and system 100 may suggest “hello, how are you?” as a response, etc.).

Anon-limiting example of system 100 in operation is as follows: ensemble model 102 may generate models 110. For example, ensemble model 102 may generate models 110 by prompting one or more LLMs using personality prompts (i.e., where one LLM represents each personality and therefore each model and/or where a different LLM represents each personality). Each of models 110 may generate a number of responses (shown as responses 112) to prompts 120 having known responses (i.e., responses represented in first subset 122a). Ensemble model 102 may select from each set of responses 112 one or more responses according to weights assigned to each model 110 (shown as weights 114) to form a subset of responses (shown as subset 116). Weights 114 may determine the frequency responses 112 from each model 110 in subset 116. For example, first model 110a may have a first weight 114 that is greater than a second weight corresponding to second model 110b, and therefore, a greater number of first responses 112a than second responses 112b may be included in subset 116. Ensemble model 102 may compare the subset of modeled/predicted answers (i.e., subset 116) to the subset of known answers (i.e., first subset 122a) to determine a similarity score (e.g., representing how similar the two sets of answers are, representing how similar the distributions are, etc.). Ensemble model 102 may update weights 114 based on the similarity score using a genetic algorithm (i.e., such that subset 116 becomes more similar to first subset 122a). Once ensemble model 102 is sufficiently trained (i.e., the optimal weights 114 are determined, the similarity score satisfies a threshold, etc.), ensemble model 102 may be used to predict/estimate answers to new prompts (i.e., generate second subset 122b). In various embodiments, ensemble model 102 generates an output (shown as output 118) that represents a predicted response to a prompt. For example, output 118 may be a single answer that is part of a distribution of answers represented by second subset 122b. In various embodiments, comparing subset 116 to first subset 122a includes comparing a maxima of the distributions (e.g., a majority response from each subset). In some embodiments, comparing subset 116 to first subset 122a includes comparing a variance between responses in each subset.

Each set of responses 112 may include one or more responses. For example, each model 110 may be prompted 10 times to generate ten responses. In various embodiments, a variable (e.g., a temperature value) may be used to vary responses between prompts. In some embodiments, a number of response are generated using a single prompt (e.g., “produce a distribution of responses”). Additionally or alternatively, each prompt may include an entropy factor to cause the responses to vary between prompts (e.g., to simulate variance in human responses, etc.).

In various embodiments, system 100 performs pre-processing. For example, system 100 may pre-process prompts 120 or answers (e.g., first subset 122a) by transforming text into a vector of size k where each entry in the vector represents a label (e.g., answer, etc.). Pre-processing may include normalizing inputs. As an example of pre-processing, system 100 may receive text (e.g., representing a prompt, etc.), may tokenize the text, encode the tokenized text into a vector (e.g., using a bag of words model, using term frequency and inverse document frequency, etc.), and/or may label premises and conclusions within the tokenized text. In various embodiments, determining a similarity between subset includes computing an Earth Mover's Distance (EMD) (e.g., a Wasserstein Distance). In various embodiments, system 100 normalizes the EMD value to a range of 0-1. In various embodiments, system 100 computes an Earth Mover's Similarity (EMS) as EMS(D₁, D₂)=100^{EMD(D}^{₁}^{,D}^{₂}⁾ where D₁ and D₂ are normalized probability distributions (e.g., corresponding to the subsets to be compared, etc.). It should be understood that while 100 is used as an example base for the exponent above, other values may be used (and may determine a spread in the variation between distributions, etc.).

In some embodiments, one or more sets of responses (e.g., responses 112) may share a weight (e.g., of weights 114). For example, each fold (i.e., O, C, E, A, N) may correspond to a weight and system 100 may determine a weight for each fold (e.g., where each fold includes two models that each produce a set of responses corresponding to a positive bias towards that trait and a negative bias away from that trait). In various embodiments, weights 114 are determined using a genetic algorithm via a feedback loop where system 100 iteratively compares subset 116 to first subset 122a until a threshold similarity is achieved (e.g., a similarity score is greater than a threshold, etc.). The genetic algorithm may have various parameters (e.g., 8 generations, 256 populations per generation, 128 mating parents, etc.).

System 100 may perform one or more functions. For example, system 100 may perform text completion (e.g., in a messaging application of a mobile device, etc.). As another example, system 100 may perform sentiment analysis (e.g., predict a user's response to a message or ad). As another example, system 100 may perform feature prioritization (e.g., determine which features a user is most interested in, etc.). As another example, system 100 may generate synthetic data (e.g., for political or social science research). As another example, system 100 may perform customer service optimization (e.g., determine a user's response to being offered a promotion/incentive, determine which users are most likely to have a particular response to an action, prioritize which users to serve first based on which users are willing to wait longer, etc.). As another example, system 100 may perform knowledge tracing. As another example, system 100 may function as a recommendation system (e.g., recommend new articles, etc.). As another example, system 100 may function as a mechanical turk to perform discrete on-demand tasks. As another example, system 100 may function as an automated moderator (e.g., by determining whether users would find certain comments/posts offensive, etc.).

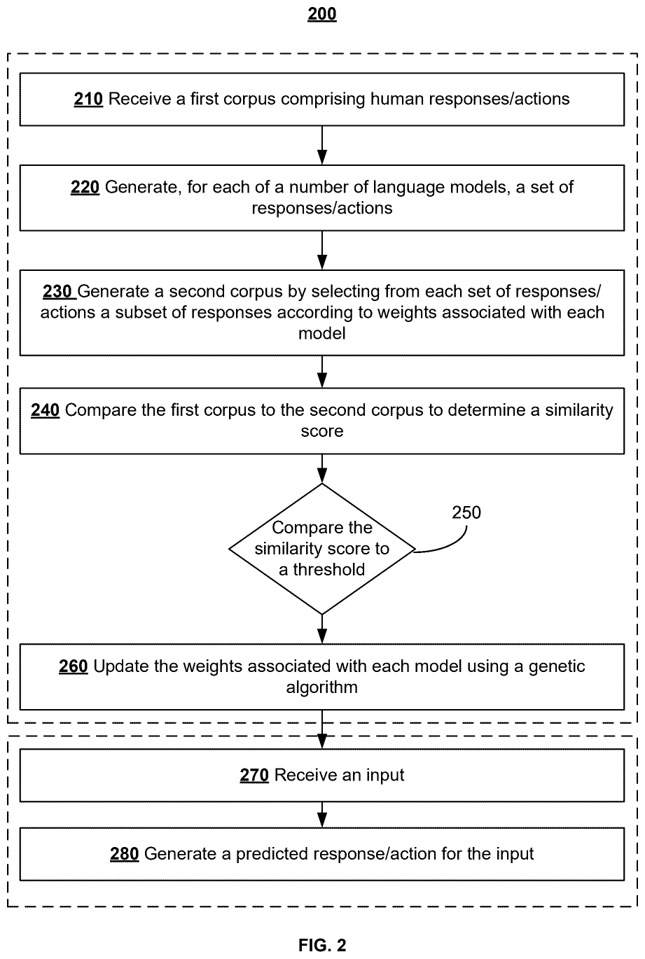

Referring now to FIG. 2, method 200 of text prediction is shown, according to an exemplary embodiment. In various embodiments, system 100 performs method 200. Method 200 may include a training phase (shown as steps 210-260) and/or an inference phase (shown as steps 270-280). In some embodiments, one or more steps in the training phase are repeated (e.g., until a performance metric is achieved, etc.).

At step 210, ensemble model 102 may receive a first corpus comprising human responses/actions. For example, ensemble model 102 may receive a number of text prompts each having corresponding real-world human responses/actions to the text prompts. In various embodiments, the first corpus includes one or more prompts. Each of the one or more prompts may be associated with a response/action.

At step 220, ensemble model 102 may generate, for each of a number of language models, a set of responses/actions to the prompts associated with the first corpus. For example, ensemble model 102 may generate ten sets of responses for each prompt using ten separate models, each representing a trait. In various embodiments, ensemble model 102 generates language models by prompting an LLM with a prompt that causes the LLM to take on a trait.

At step 230, ensemble model 102 may generate a second corpus by selecting from each set of responses/actions a subset of responses according to weights associated with each model. For example, ensemble model 102 may sample a certain number of response from each set of responses according to the weight associated with each model.

At step 240, ensemble model 102 may compare the first corpus to the second corpus to determine a similarity score. For example, ensemble model 102 may generate a similarity score using an EMS score. At step 250, ensemble model 102 may compare the similarity score to a threshold. At step 260, ensemble model 102 may update the weights associated with one or more of the models using a genetic algorithm. For example, ensemble model 102 may update the weights to cause ensemble model 102 to produce a distribution of responses to the prompts that more closely matches an empirical distribution of responses collected from real humans that responded to the same prompts. In some embodiments, ensemble model 102 only updates the weights if the similarity score does not meet the threshold. For example, ensemble model 102 may continuously repeat steps 230-260 until the second corpus is similar to the second corpus (e.g., as measured by the similarity score, etc.). In various embodiments, step 240 includes tuning a hyperparameter.

At step 270, ensemble model 102 may receive an input. For example, ensemble model 102 may receive a text input. As another example, ensemble model 102 may receive an incoming message from a messaging application. In some embodiments, step 270 includes performing pre-processing on the input. In various embodiments, the input includes a question/prompt. In various embodiments, the question/prompt is a question/prompt for which a response is not known. For example, ensemble model 102 may be used to predict one or more human responses (e.g., a distribution, a single response, etc.) to a novel prompt.

At step 280, ensemble model 102 may generate a predicted response/action for the input. For example, ensemble model 102 may generate a distribution of expected/precited response to the input and may select a response/action from the distribution of expected/predicted responses. In various embodiments, step 280 includes displaying the predicted response/action (or a number thereof) on a display.

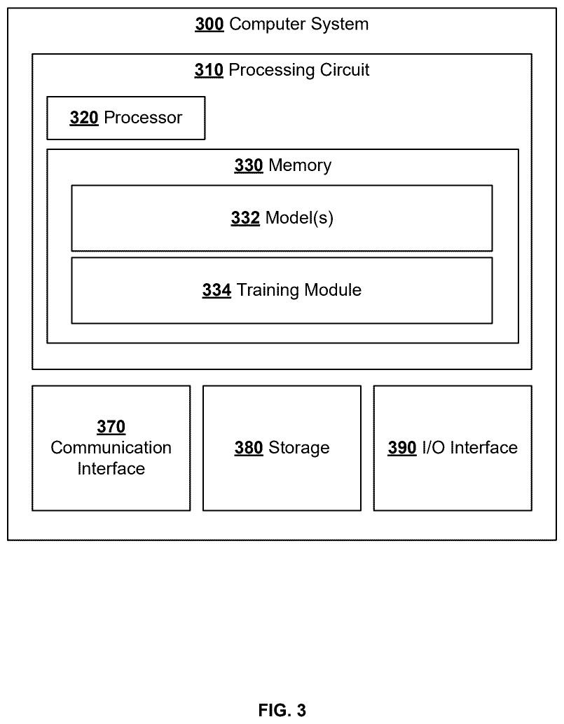

Referring now to FIG. 3, computer system 300 is shown, according to an exemplary embodiment. Computer system 300 may implement ensemble model 102. Additionally or alternatively, computer system 300 may perform one or more steps of method 200. Computer system 300 may include one or more processing circuit(s) 310, communication interface 370, storage 380, and/or I/O interface 390. Processing circuit(s) 310 may include one or more processor(s) 320 and/or memory/memories 330. Processor(s) 320 may be a general purpose or specific purpose processor, an application specific integrated circuit (ASIC), one or more field programmable gate arrays (FPGAs), a group of processing components, or other suitable processing components. Processor(s) 320 is configured to execute computer code or instructions stored in memory/memories 330 or received from other computer readable media (e.g., CDROM, network storage, a remote server, etc.). In some embodiments, one or more of processor(s) 320 are (or include) specialized processors such as GPUs. Memory/memories 330 may include one or more devices (e.g., memory units, memory devices, storage devices, and/or other computer-readable media) for storing data and/or computer code for completing and/or facilitating the various processes described in the present disclosure. Memory/memories 330 may include random access memory (RAM), read-only memory (ROM), hard drive storage, temporary storage, non-volatile memory, flash memory, optical memory, or any other suitable memory for storing software objects and/or computer instructions. Memory/memories 330 may include database components, object code components, script components, or any other type of information structure for supporting the various activities and information structures described in the present disclosure. Memory/memories 330 may be communicably connected to processor(s) 320 via processing circuit(s) 310 and may include computer code for executing (e.g., by processor(s) 320) one or more of the processes described herein. For example, memory/memories 330 may have instructions stored thereon that, when executed by processor(s) 320, cause processing circuit(s) 310 to (i) receive a first corpus, (ii) generate, for each of a number of language models, a set of responses/actions, (iii) generate a second corpus by selecting from each set of responses/actions a subset of responses according to weights associated with each model, (iv) compare the first corpus to the second corpus to determine a similarity score, (v) compare the similarity score to a threshold, (vi) update the weights associated with each model using a genetic algorithm (e.g., train an ensemble model), (vii) receive an input, and/or (ix) generate a predicted response/action for the input using the trained ensemble model. In various embodiments, memory/memories 330 include one or more model(s) 332 and training module 334. Model(s) 332 may be and/or include a natural language model such as a large language model (LLM). In various embodiments, model(s) 332 run on a remote server and computer system 300 prompts model(s) 332 via an interface (e.g., while model(s) 332 are executed by the server). Model(s) 332 may be and/or include a distributed neural network distributed across a number of processor(s) 320 and/or processing circuit(s) 310. For example, model(s) 332 may be a distributed neural network executed on a server cluster. In various embodiments, model(s) 332 include one or more sub-models. For example, model(s) 332 may be and/or include an ensemble machine learning model (e.g., an artificial intelligence model such as a neural network) that prompts one or more external models in an agentic manner. In some embodiments, one or more of model(s) 332 include a feed-forward neural network. Training module 334 may be implemented as a computer program. In various embodiments, training module 334 trains one or more of model(s) 332. For example, training module 334 may train an ensemble model as described in FIG. 2. Training module 334 may implement one or more training algorithms to train one or more of model(s) 332. For example, training module 334 may implement (i) stochastic gradient descent, (ii) decision tree learning, (iii) random forest learning, and/or the like.

Communication interface 370 may facilitate communication with one or more systems/devices. For example, computer system 300 may communicate via communication interface 370 with an external LLM (e.g., such as a server running an LLM). Communication interface 370 may be or include wired or wireless communications interfaces (e.g., jacks, antennas, transmitters, receivers, transceivers, wire terminals, etc.) for conducting data communications with external systems or devices. In various embodiments, communications via communication interface 370 is direct (e.g., local wired or wireless communications). Additionally or alternatively, communications via communication interface 370 may utilize a network (e.g., a WAN, the Internet, a cellular network, etc.).

Storage 380 may store data/information associated with the various methods/operations described herein. For example, storage 380 may store neural network parameters, ensemble model weights, and/or the like. Storage 380 may be and/or include one or more memory devices (e.g., hard drive storage, temporary storage, non-volatile memory, flash memory, optical memory, and/or any other suitable memory device).

I/O interface 390 may facilitate input/output operations. For example, I/O interface 390 may include a display capable of presenting information from a user and an interface capable of receiving input from the user. In some embodiments, I/O interface 390 includes a display device configured to present a GUI to a user. I/O interface 390 may include hardware and/or software components. For example, I/O interface 390 may include a physical input device (e.g., a mouse, a keyboard, a touchscreen device, etc.) and software to enable the physical input device to communicate with computer system 300 (e.g., firmware, drivers, etc.). In some embodiments, I/O interface 390 includes an API to facilitate interaction with external systems (e.g., an augmented reality display system, etc.). For example, an engineer may use I/O interface 390 to view a predicted response/action (e.g., the output of step 280, output 118, etc.).

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

What is claimed is:

1. A non-transitory computer-readable storage medium having instructions stored thereon that, when executed by a processor, cause the processor to:
train an ensemble model to generate a trained ensemble model by:
receiving a first corpus comprising human responses to a plurality of prompts;
generating, for each model in a plurality of language models that simulate different personality traits or different combinations of personality traits, a set of responses to the plurality of prompts;
generating a second corpus by selecting from each set of responses a subset of responses according to weights associated with each model;
comparing the first corpus and the second corpus to determine a similarity score; and
in response to determining that the similarity score is less than a threshold, updating the weights associated with each model using a genetic algorithm;
receive input text; and
generate a predicted response to the input text using the trained ensemble model.

2. The non-transitory computer-readable storage medium of claim 1, wherein each model simulates a different five-factor model (FFM) factor or a different combination of FFM factors.

3. The non-transitory computer-readable storage medium of claim 1, wherein generating the predicted response comprises generating a plurality of predicted responses and selecting from the plurality of predicted responses, the predicted response.

4. The non-transitory computer-readable storage medium of claim 1, wherein the instructions cause the processor to update a graphic display with the predicted response.

5. The non-transitory computer-readable storage medium of claim 1, wherein determining the similarity score comprises computing an earth mover distance (EMD) based on the first corpus and the second corpus.

6. The non-transitory computer-readable storage medium of claim 1, wherein training the ensemble model comprises generating the plurality of language models by prompting one or more large language models using one or more prompts.

7. A method for generating a text prediction, comprising:
receive input text;
generate, using an ensemble artificial intelligence (AI) model, a plurality of sets of responses to the input text, wherein each set of responses simulates responses associated with a different personality trait or a different combination of personality traits;
generating, from the plurality of sets of responses, a subset of responses by selecting from each set of responses one or more responses based on a weight associated with each set;
selecting, from the subset of responses, a predicted response; and
updating a graphic display with the predicted response.

8. The method of claim 7, wherein each set of responses simulates a different five-factor model (FFM) factor or a different combination of FFM factors.

9. The method of claim 7, wherein the ensemble model includes a plurality of models that each simulate a different FFM factor or a different combination of FFM factors.

10. The method of claim 8, wherein the ensemble model is trained using a corpus comprising human responses to a plurality of prompts.

11. The method of claim 10, wherein training the ensemble model comprises adjusting the weight associated with each set using a genetic algorithm to increase a similarity between the corpus and the subset of responses.

12. The method of claim 10, wherein generating the plurality of sets of responses comprises prompting one or more large language models using one or more prompts, wherein the one or more prompts comprise at least a portion of the input text.

13. A text prediction system, comprising:
an ensemble artificial intelligence (AI) model comprising:
a plurality of language models, each of which simulate a different personality trait or a different combination of personality traits;
a plurality of weights, each associated with a model of the plurality of language models, wherein each weight of the plurality of weights describes a relative contribution of the model to a response sample;
a processing circuit including a processor and memory, the memory having instructions stored thereon that, when executed by the processor, cause the processor to:
receive input text;
generate, using the ensemble AI model, a plurality of responses to the input text; and
update a graphic display with at least one of the plurality of responses.

14. The text prediction system of claim 13, wherein the instructions further cause the processor to train the ensemble AI model by:
causing each model of the ensemble AI model to generate a set of responses to a first corpus comprising human responses to a plurality of prompts;
selecting, from each set of responses, one or more responses based on the weight associated with each model to generate a second corpus;
comparing the first corpus to the second corpus to generate a similarity score; and
adjusting a hyperparameter of the ensemble model based on the similarity score.

15. The text prediction system of claim 14, wherein generating the plurality of responses comprises performing sentiment analysis.

16. The text prediction system of claim 14, wherein generating the plurality of responses comprises generating a set of responses for each model and selecting from each set of responses a subset of responses to form the plurality of responses.

17. The text prediction system of claim 16, wherein each set of responses comprises a distribution of responses associated with predicted responses of a hypothetical person having a specific personality trait.

18. The text prediction system of claim 14, wherein each model simulates a different FFM factor or a different combination of FFM factors.

19. The text prediction system of claim 18, wherein the FFM factors comprise openness, conscientiousness, extraversion, amicability/agreeableness, and neuroticism.

20. The text prediction system of claim 13, wherein generating the plurality of responses comprises prompting the ensemble model with one or more prompts that comprise at least a portion of the input text.
